(19) United States
(12) Patent Application Publication
(10) Pub. No.: US 2006/0126330 A1
(43) Pub. Date: Jun. 15, 2006

(54) Luminous floor with a change of light sources

(75) Inventor: George Yen, Chungho City (TW)

Correspondence Address: TROXELL LAW OFFICE PLLC, 5205 LEESBURG PIKE, SUITE 1404, FALLS CHURCH, CA, 22041, US

(73) Assignee: Star-Reach Corporation

(21) Appl. No.: 11/011,171

(22) Filed: Dec. 15, 2004

(51) Int. Cl. F21V 33/00

(52) U.S. Cl. 362/253

(57) ABSTRACT

The present invention discloses a luminous floor with change of light sources; its overall light source is as small as about 12 mm; the height of the floor including tempered glass is about 35 mm only; the LED lamps are connected in series to save the trouble of wiring the LED lamps to a control system one by one; a footer, a cross-shape base, and a longitudinal and transversal derived beam mounted across the bases to define a floor frame extended towards to all directions. The serially connected LED lamp modules are installed in the middle of a surface under the derived beam, and a T-shape shockproof plastic stripe sheathes on the derived beam, and a reflective board and a nebulization broad are disposed at a bracket on a side of the derived beam. A piece of thick glass or tempered glass can be placed on the T-shape shockproof plastic stripe. With the instructions given by a control circuit, the LED module can emit lights with change of light sources to obtain a magnificent luminous floor.

### FIELD OF THE INVENTION

The present invention relates to a luminous floor, more particularly to a luminous floor with a change of light sources.

### BACKGROUND OF THE INVENTION

In the area of lamps, its simple purpose for providing light at an early stage has changed to motivating visual effects, particularly after the selling price of light emitting diodes (LEDs) drops drastically, the LED device has become a mainstream for optical visions. Since an LED consumes low power, gives high brightness and easiness for controlling the LED intensity by a drive circuit, it offers blinking and different color combinations to offer different color changes, therefore the LED is a medium very suitable for being used as a visual light source.

Besides the lamination purpose, most light sources are usually used for providing color light sources to external walls, but its application on a lamination floor is not common. If the different color light emitting diode (LED) can go with the light intensity and the combination of blinking changes and obtain a luminous floor with a good visual effect, the special design of the present invention will utilize a simplified control circuit and LED application to make the luminous lamp board as small as about 12 mm wide. With the application of a light guider, the entire light source structure can be as small as about 12 mm. Further, the special structural design for the height of the entire floor including the tempered glass is about 35 mm; the LED lamps are connected in a series to avoid the trouble of connecting the LED lamps to the control board one by one; an aluminum frame also has the heat dissipation effect for the LED; a cross-shape stand also has the horizontal adjusting effect; and a rectangular channel on the aluminum frame can combine with a shockproof silicon gel to prevent it from moving.

### SUMMARY OF THE INVENTION

Therefore, the primary objective of the present invention is to provide a luminous floor with change of light sources.

### BRIEF DESCRIPTION OF THE DRAWINGS

FIG. 1 is an exploded view of the present invention.

FIG. 2 is an exploded view of another preferred embodiment of the present invention.

FIG. 3 is a schematic circuit diagram of the present invention.

FIG. 4 is a block circuit diagram of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

The luminous floor with a change of light sources in accordance with the present invention includes an electronic section and a floor structure section. The electronic section comprises a control unit 1, a driver program unit 11, a power supply unit 12 and an LED luminous unit 13. The floor structure comprises a footer 2, a cross-shape base 3, a derived beam 4, an LED lamp module 5, a T-shape shockproof plastic stripe 6, a reflective board 7, an nebulization board 8, and a piece of thick or tempered glass 9.

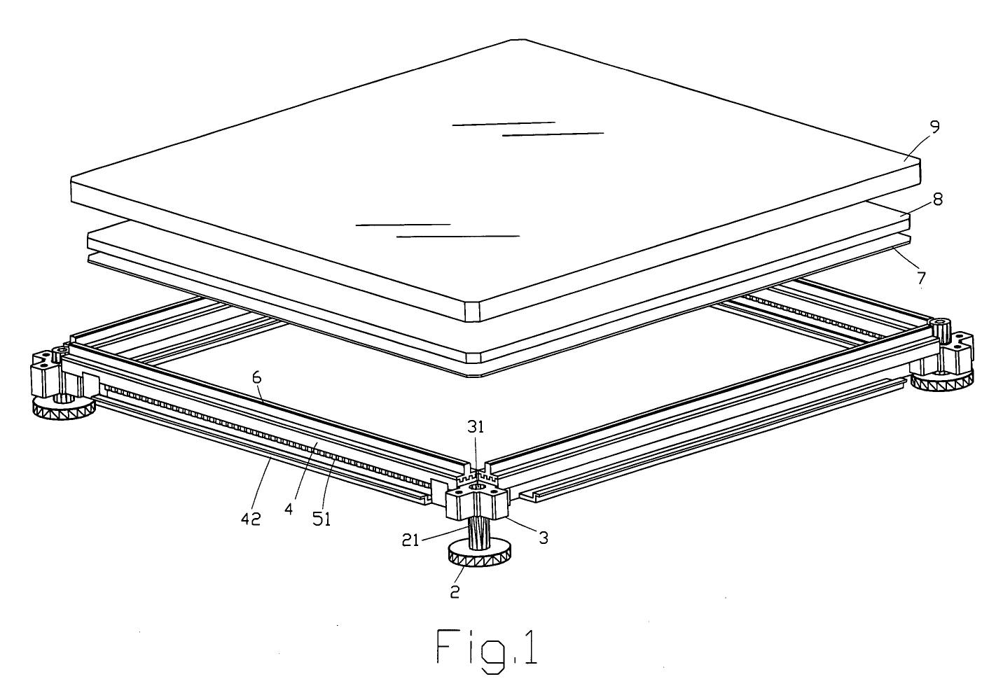

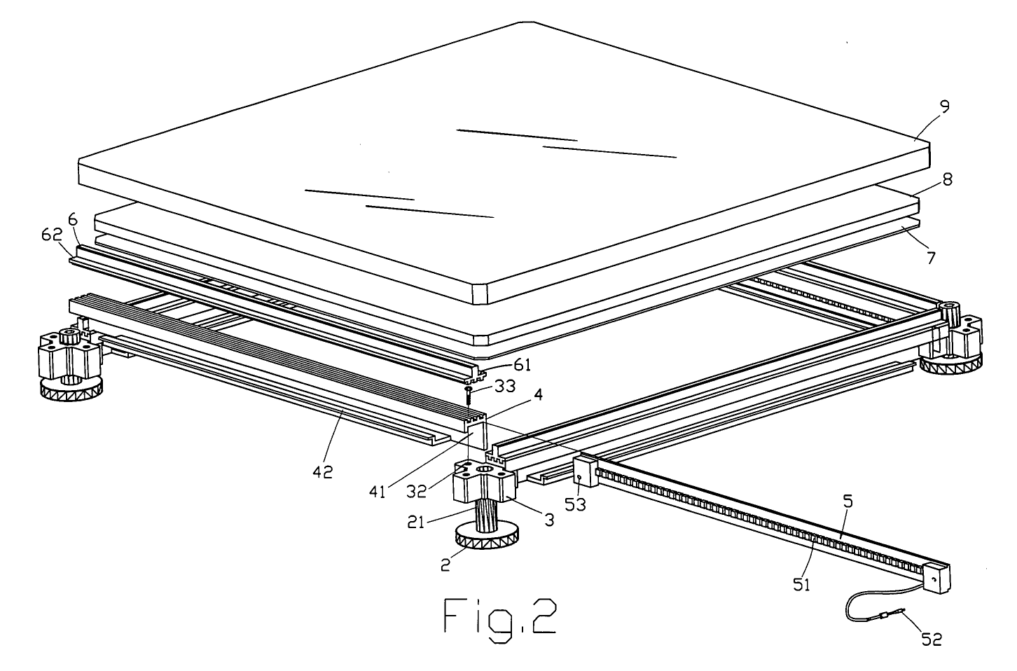

In FIGS. 1 and 2, the floor comprises a plurality of footers 2 as its base, and the vertical pillar of the footer 2 is a screw rod 21, and each footer 2 is used for coupling the screw rod 21 into a screw hole 31 of the cross-shape base 3 and adjusting the cross-shape base 3 vertically up and down; and a screw hole 32 is disposed at the external edge of the cross-shape base 3.

The foregoing derived beam 4 is formed basically by extruding aluminum materials and has the function of dispersing the heat of the LED heat source. Both ends of the derived beam 4 are disposed across the cross-,shape base 3 and fixed by a screw 33. The derived beam 4 reserves an accommodating space 41 underneath and a latch bracket 42 extended transversally downward. An LED lamp stripe module 5 having a plurality of different colored LED bulbs 51 serially connected and disposed thereon is accommodated in the accommodating space 41, a connecting terminal 52 and a connecting socket 53 are disposed thereon for connecting each LED lamp stripe module 5.

With the foregoing plurality of footers 2, cross-shape bases 3 and derived beams 4, the floor frames with the required quantity or area can be assembled quickly, the latch bracket 42 in each frame can receive the reflective board 7 and the nebulization board 8. A T-shape shockproof plastic stripe 6 is sheathed onto each derived beam 4, and a groove 6162 is disposed individually on both sides of the T-shape shockproof plastic stripe 6 for receiving a piece of thick or tempered glass 9 to define the surface of the luminous floor.

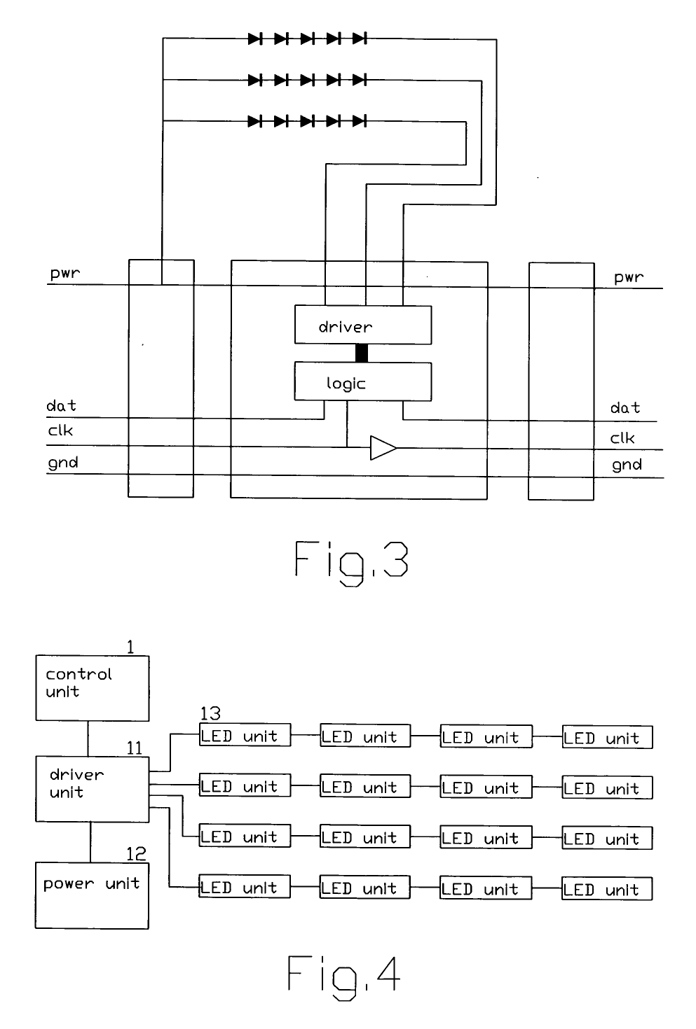

In FIGS. 3 and 4, the electronic section comprises a control unit 1, a driver program unit 11, a power supply unit 12 and an LED luminous unit 13; wherein the control unit 1 and the driver program unit 11 control each LED luminous unit 13 (LED lamp stripe module 5) to light up, change colors and change blinking in the sequence according to the instructions given. Different light sources can be put into the reflective board 7 for their reflection and diffusion, and glaring light sources are emitted from the nebulization board 8.

What is claimed is:

1. A luminous floor with change of light sources, comprising an electronic section and a floor structure section; said electronic section including a control unit, a driver program unit, a power supply unit and an LED luminous unit, and said control unit and said driver program unit controlling said LED luminous unit to change brightness, color and blinking in sequence according to an instruction given, and various different light sources being reflected and diffused by a reflective board and said glaring light source being emitted from a nebulization board; said floor structure section including a frame being comprised of a plurality of footers, cross-shape bases and derived beams, a reflective board, a nebulization board and a thick or a tempered glass being disposed on said frame, and said plurality of footers being a base, and a vertical pillar of said footer being a screw rod for adjusting said cross-shape base vertically up and down, and a screw hole being disposed at the external edge of said cross-shape base, and said plurality of derived beams having the function of dissipating the heat of an LED heat source and both ends being disposed across said cross-shape base and fixed by a screw, and an accommodating space being reserved below said derived beam and a latch bracket being transversally extended downward, and said accommodating space being capable of receiving an LED lamp stripe module having a plurality of different color LED bulbs serially connected thereon and a connecting terminal and a connecting socket for coupling said each LED lamp stripe module, and a reflective board and a nebulization board being disposed on said latch bracket in said each frame, and a T-shape shockproof plastic stripe being sheathed onto said each derived beam, and a groove disposed on each of both sides of said T-shape shockproof plastic stripe for installing a piece of thick glass or tempered glass to form the surface of said luminous floor.
